(19) United States
(12) Patent Application Publication
(10) Pub. No.: US 2010/0030526 A1
(43) Pub. Date: Feb. 4, 2010

(54) AXIAL BOLTED FLANGE DESIGN METHODS AND SYSTEMS

(76) Inventors: Robert Theodor Brooks, Orlando, FL (US); Jonathan Ariel Scott, Vernon, CT (US); Garon R. Munch, Kensington, CT (US); Benjamin Adric Dunn, Hartford, CT (US); Ralph N. Green, Glastonbury, CT (US); Cal A. Elliott, Pembroke Pines, FL (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/185,285

(22) Filed: Aug. 4, 2008

(51) Int. Cl. G06F 17/50

(52) U.S. Cl. 703/1

(57) ABSTRACT

A method of designing an axial bolted flange joint includes the use of a common, controlled spreadsheet that includes part and assembly drawings, dimensions, equations, materials properties, and design limits and design criteria that generates alerts to the user during the design process. Drawings are updated by the spreadsheet as parameters are changed and are available as final drawings at any stage of the method. After the user achieves an acceptable preliminary design in the spreadsheet, the data from the spreadsheet and/or updated drawings are imported into a solids modeling program. A finite elements program imports data from the solids modeling program to perform a stress analysis. The data in the spreadsheet may be modified, if necessary, based upon the stress analysis results.

### BACKGROUND

This disclosure relates to a method of designing axial bolted flange joints in aerospace applications, for example.

In aerospace applications, axial bolted flange joints are prevalent for securing various axially arranged components to one another. For example, these joints are commonly used in turbine engines for industrial, commercial and military applications. In one example, turbine and compressor housing case portions are secured to one another using axial flange joints.

At least one known process for designing axial bolted flange joints relies upon many sources of information. For example, design parameters, such as torque values, are derived from design manuals. Material properties, such as yield and ultimate operating temperatures, are looked up by the designer. Many calculations are done by hand or in uncontrolled spreadsheets. The designer may also make conservative assumptions for any unknown values. As a result of the numerous sources of information, each source may create opportunities for errors such as, but not limited to, geometry and transcription errors.

The known process is also labor intensive. Generating a detailed analysis of a given design may take around nine weeks. Completing a more cursory analysis of the design may take up to six weeks. Finite elements analysis, which is generally used to evaluate each proposed design as part of the design process, is also time consuming. If further modification is desirable, the analysis process generally starts over again and consumes additional time. Generally, drawings are generated after final finite element analysis has occurred, which adds more time to the process. Structural analysis is then conducted using different software packages, which may also lead to inconsistencies in results that might not relate to the initial design parameters.

What is needed is systems and methods of designing an axial bolted flange that is faster and more reliable.

### SUMMARY

A method of designing an axial bolted flange joint is disclosed. The method includes the use of a common, controlled spreadsheet that includes part and assembly illustrations, dimensions, equations, materials properties, and design limits and design criteria that generates alerts to the user during the design process. Using the controlled spreadsheet may identify many early design problems and prevent common errors. Drawings are updated by the spreadsheet as parameters are changed and are available as final drawings at any stage of the method. After the user has achieved an acceptable preliminary design in the spreadsheet, the data from the spreadsheet and/or updated drawings are imported into a solids modeling program. A finite elements program imports data from the solids modeling program to perform a stress analysis. The data in the spreadsheet may be modified, if necessary, based upon the stress analysis results.

Accordingly, the disclosed method of designing an axial bolted flange provides a faster and more reliable design process.

### BRIEF DESCRIPTION OF THE DRAWINGS

The disclosure may be further understood by reference to the following detailed description when considered in connection with the accompanying drawings wherein:

FIG. 1 is a general flow chart of an example methods and systems.

FIG. 2 is a flow chart of a spreadsheet according to the disclosed methods and systems.

FIG. 3 illustrates an example axial bolted flange drawing and dimensional parameters in the spreadsheet.

FIG. 4 illustrates assembly parameters in the spreadsheet for the axial bolted flange.

FIG. 5 illustrates a bolt drawing in the spreadsheet.

FIG. 6 illustrates a nut drawing in the spreadsheet.

### DETAILED DESCRIPTION

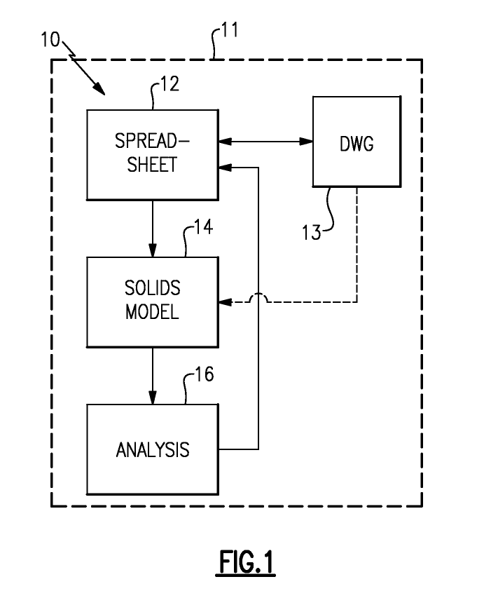

An example method 10 of designing an axial bolted flange joint is shown schematically in FIG. 1. The method 10 is performed using a computing system 11. It should be appreciated that use of the term block is synonymous with a method step. It should also be noted that a computing system may be used to implement various functionality disclosed in this application. In terms of hardware architecture, such a computing system may include a processor, memory, and one or more input and/or output (I/O) device interface(s) that are communicatively coupled via a local interface. The local interface may include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor may be a custom made or commercially available processor, a central processing unit (CPU), an auxiliary processor among several processors associated with the computing device, a semiconductor based microprocessor (in the form of a microchip or chip set) or generally any device for executing software instructions.

The memory may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory may also have a distributed architecture, where various components are situated remotely from one another, but may be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing system is in operation, the processor may be configured to execute software stored within the memory, to communicate data to and from the memory, and to generally control operations of the computing device pursuant to the software. Software in memory, in whole or in part, is read by the processor, perhaps buffered within the processor, and then executed.

The method 10 includes one or more controlled spreadsheets 12 as the basis of the design process to facilitate improving accuracy and reducing analysis time. Generally, information from the spreadsheet 12 is imported to a solids model 14 for generation of the structures of the joint, such as flanges, bolts, nuts and washers. Specifically, information from assembly and detail parts drawings 13 are imported from the spreadsheet 12 and/or from updated drawings 13 into the solids model 14. One example solids modeling software is UNIGRAPHICS (UG). The solids model 14 data is imported to a finite elements model 16, such as ANSYS, to perform a stress analysis of the joint. The results from the finite elements model 16 are compared to design criteria to determine whether the proposed design is acceptable. If the proposed design does not meet design criteria, then operation of the method returns to the spreadsheet 12 and the user my modify the relevant design parameters in the spreadsheet to produce an acceptable design.

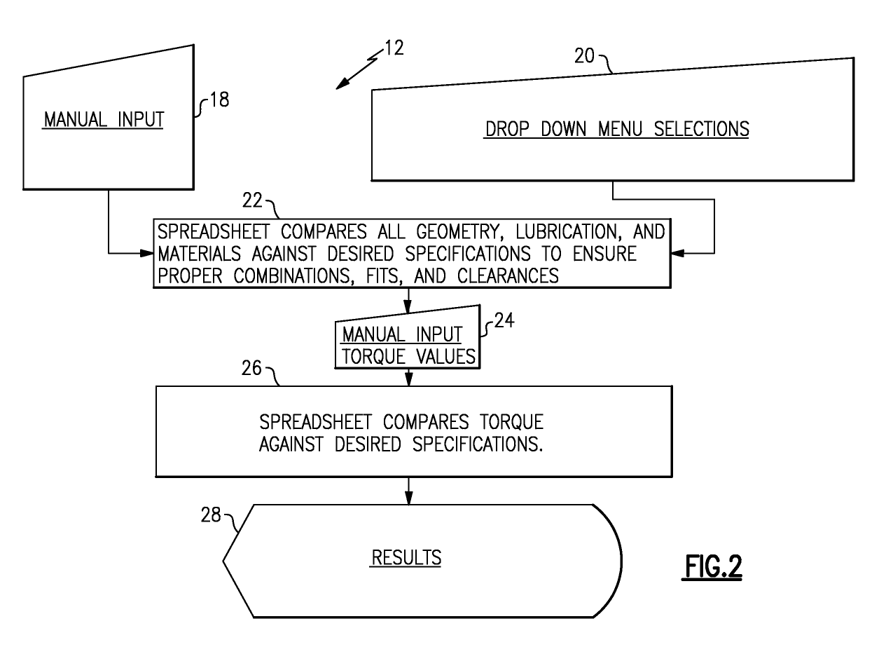

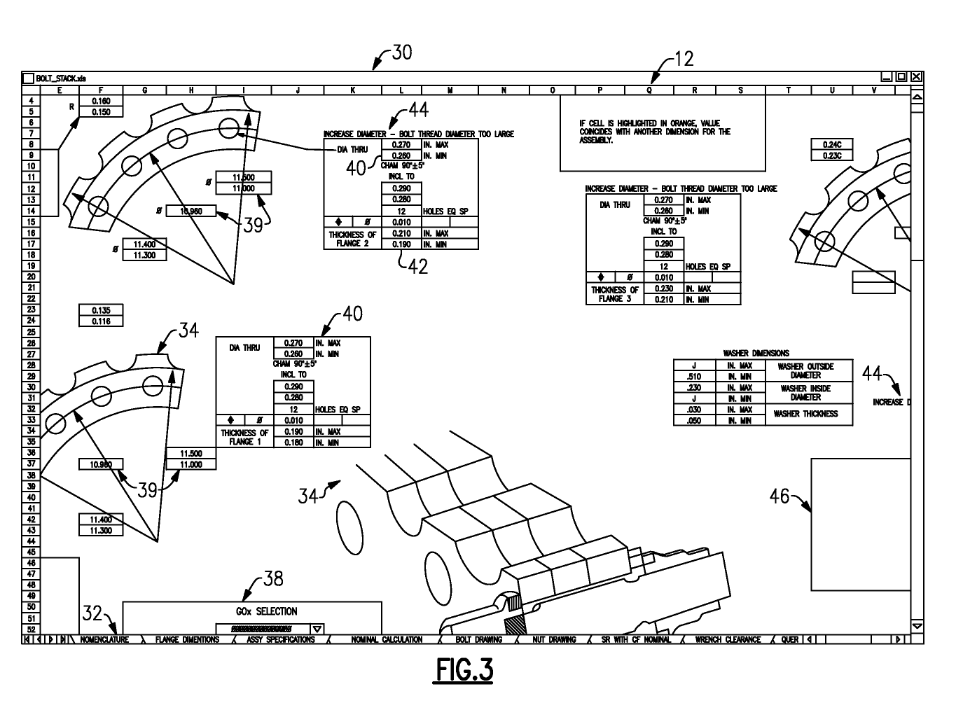

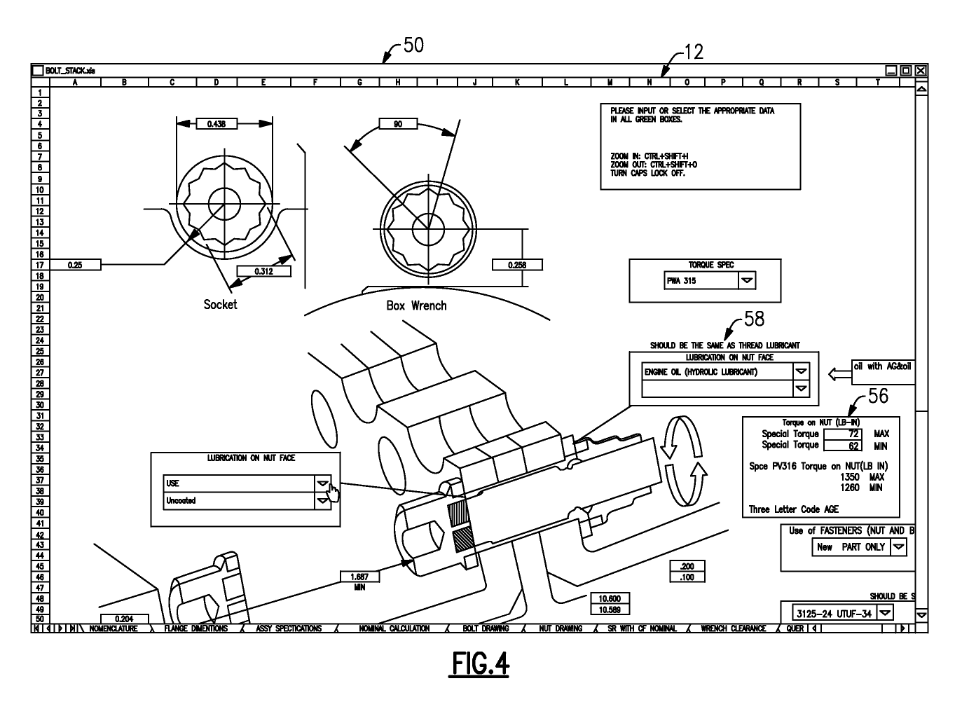

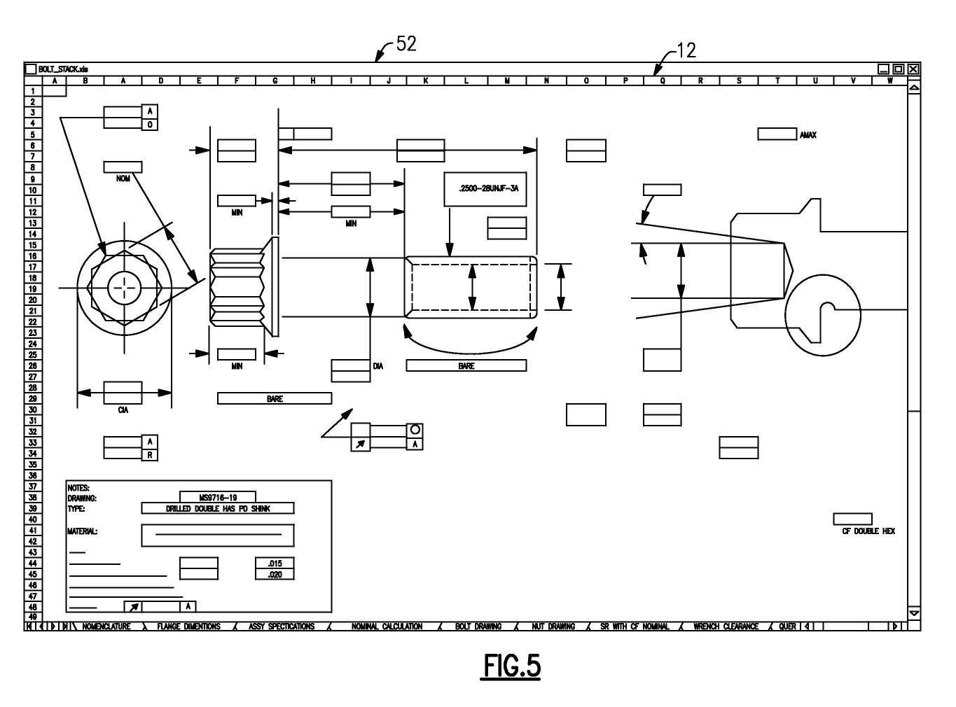

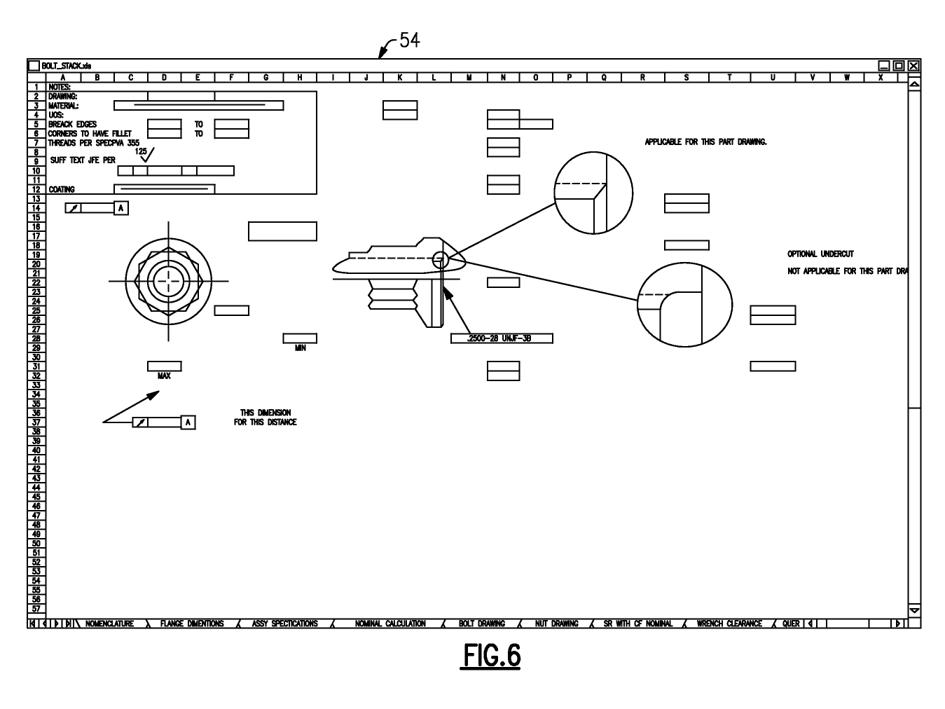

The spreadsheet 12 includes features that are schematically depicted in FIG. 2. An example spreadsheet screen 30 of joint data is shown in FIG. 3. The spreadsheet 12 is stored in an EXCEL file format, for example, and is configured as a workbook with multiple pages 32 in the example shown. The pages 32 include component illustrations 34, dimensions and information relating to the joint. For example, assembly specifications 50, bolt drawings 52 and nut drawings 54 are provided on pages 32, as respectively illustrated in FIGS. 4-6. Other information may also be provided in the common spreadsheet 12, such as nomenclature, equations and calculations, wrench clearances and other information relating to the joint.

As shown in FIG. 2, information (block 18), such as temperatures, flange and washer geometry and external loads, is manually input into fields in the spreadsheet 12. The spreadsheet 12 also includes drop-down menus (block 20, 38 in FIG. 3) that enable the user to select, for example, bolt and nut sizes, lubrications, materials and drawing numbers from an existing body of reference data for nuts and bolts. The data from the drawing associated with the selected drawing number is imported into the spreadsheet 12. For example, as shown in FIG. 3, data relating to the component illustrations 34 are imported from the drawings along with data such as, but not limited to, dimensional data 39. Linked data 40 is highlighted for the user in some manner, such as by color-coding, to convey to the user that altering that data will affect other parameters related to the joint. In one example, linked data 40 appears in an orange box. The dimensional data 39 and other information may be altered to create a joint having new design features. Drawings 13 (FIG. 1) are updated concurrently so that printable blueprints are available simultaneously, thus shortening the design process. In one example, the drawings 13 are provided in a write-accessible library of drawings.

Next, the information and menu selections from (blocks 18 and 20) the spreadsheet 12 are input into spreadsheet 12, which is programmed to compare the geometries, lubrications, materials and other information against desired specifications to facilitate ensuring desired combinations, fits and clearances (block 22 in FIG. 2). The desired specifications may be preferred design parameters stored in the spreadsheet, for example. Data fields 42 may be highlighted in some manner, such as by color-coding, to inform the user whether that field is a desired or undesired parameter. The desired or undesired parameters may be preferred or non-preferred design parameters stored in the spreadsheet, for example. Alerts 44 may appear, prompting the user to revise a dimension or other parameter, as shown in FIG. 3. For example, an acceptable parameter is highlighted in green, and an unacceptable parameter is highlighted in red. Torque values (shown at 56 in FIG. 4) are manually input by the user into the spreadsheet 12 (block 24 in FIG. 2). The spreadsheet compares the torque values to desired torque specifications (block 26, FIG. 2). If out-of-spec values are chosen, warnings 58 (FIG. 4) alert the user to ensure that proper torque values are input by the user.

The spreadsheet 12 facilitates ensuring that accurate information is provided in the solid modeling and finite elements analysis stages of the method 10. The spreadsheet 12 provides updated, printable nut and bolt drawings 13 (FIG. 1), preload values, assembly torque and strength margins (block 28 in FIG. 2) prior to beginning solid modeling and finite elements analysis. The updated assembly drawings 13 or detail parts drawings associated with the spreadsheet 12 are imported into UG for solids modeling 14. In one example, the relevant drawings 13 are selected in UG, by a drop-down menu, for example. The solids model 14 is imported into ANSYS for finite elements analysis 16. The results from the finite elements analysis 16 are output for review by the user. If the resultant stresses are not acceptable, then the user returns to the spreadsheet 12 to modify the relevant parameters needed to generate an acceptable design. However, if the stresses are acceptable, then the final drawings are already available for printing and use since they have been updated through the spreadsheet 12.

Although an example embodiment has been disclosed, a worker of ordinary skill in this art would recognize that certain modifications would come within the scope of the claims. For that reason, the following claims should be studied to determine their true scope and content.

What is claimed is:

1. A method of designing an axial bolted flange joint using a computer, the method comprising the steps of:
a) providing a spreadsheet including axial bolted flange joint component parameters and drawings associated with the spreadsheet;
b) receiving updated component parameters from the spreadsheet to produce updated drawings prior to performing steps c) and d);
c) importing data from at least one of the spreadsheet and the updated drawings to a solids modeling program; and
d) importing data from the solids modeling program to a finite elements analysis program for stress analysis of the axial bolted flange joint.

2. The method according to claim 1, wherein the axial bolted flange joint component parameters include at least one of component illustrations, dimensions, equations, materials, lubrication properties and design limits.

3. The method according to claim 1, wherein the drawings and the updated drawings are provided in a library of drawings.

4. The method according to claim 1, wherein the spreadsheet includes component illustrations on a page in the spreadsheet.

5. The method according to claim 2, wherein the spreadsheet includes alerts, the alerts communicating to a user that one of the axial bolted flange component parameters does not meet at least one of the design limits, the spreadsheet performing a comparison of dimensions, materials and lubrications to determine that desired specifications are achieved, the alert provided if undesired specifications are achieved.

6. The method according to claim 5, wherein the alerts correspond to color-coded data fields.

7. The method according to claim 1, wherein the spreadsheet includes drop-down menus having selections corresponding to the axial bolted flange component parameters including at least one of bolt and nut sizes, lubrications, materials and drawing numbers.

8. The method according to claim 7, wherein selecting a drawing number imports drawing data into the spreadsheet.

9. The method according to claim 1, wherein the axial bolted flange component parameters include at least one of temperature, flange and washer geometries, and external loads.

10. The method according to claim 2, wherein the axial bolted flange component parameters include torque values.

11. The method according to claim 10, wherein the spreadsheet includes alerts, the alerts communicating to a user that the torque value does not meet at least one of the design limits, the spreadsheet performing a comparison of the torque value to desired specifications, the alert provided if undesired specifications are achieved.

12. The method according to claim 1, wherein the spreadsheet provides preload values, assembly torques and strength margins.

13. The method according to claim 1, further comprising the step of e) outputting the results from the finite elements analysis.

14. The method according to claim 13, further comprising the step of f) revising the spreadsheet of step a) and repeating steps b)-d).

15. A computer system for designing an axial bolted flange joint, the computer system comprising:
a processor programmed to provide a spreadsheet including axial bolted flange joint component parameters and drawings associated with the spreadsheet, to receive updated component parameters from the spreadsheet to produce updated drawings, to import data from at least one of the spreadsheet and the updated drawings to a solids modeling program, and to import data from the solids modeling program to a finite elements analysis program for stress analysis of the axial bolted flange joint; and
wherein the updated drawings are produced prior to the data being imported from the at least one of the spreadsheets and the solids modeling program.
